(19) United States
(12) Patent Application Publication
(10) Pub. No.: US 2006/0032940 A1
(43) Pub. Date: Feb. 16, 2006

(54) Injection nozzle for internal combustion engines

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/538,032

(22) PCT Filed: Apr. 23, 2004
(86) PCT No.: PCT/DE04/00848

§ 371 Date: Jun. 8, 2005

(30) Foreign Application Priority Data
Jun. 10, 2003 (DE) 10326046.3

(51) Int. Cl. F02M 47/02

(52) U.S. Cl. 239/88; 239/533.2

(57) ABSTRACT

An internal combustion engine having a nozzle body equipped with at least one injection opening and a nozzle needle guided in a needle guide and is able to control the injection of fuel through the at least one injection opening. A control piston drive-coupled to an actuator has a first control surface, if the nozzle needle has a compensator surface that is hydraulically coupled to the first control surface via a first hydraulic path, and a second hydraulic path is able to hydraulically couple the first control surface to a supply line that supplies highly pressurized fuel to the at least one injection opening.

### PRIOR ART

The present invention relates to an injection nozzle for internal combustion engines with the characteristics of the preamble to claim 1.

An injection nozzle of this kind is known, for example, from DE 100 60 836 C1 and has a nozzle body provided with at least one injection opening. The nozzle body also contains a needle guide in which a nozzle needle is guided. The nozzle needle is able to control the injection of fuel through the at least one injection opening. In the known injection nozzle, a supply line that supplies highly pressurized fuel to the at least one injection opening contains a control valve that is able to control the fuel supply through the supply line to the at least one injection opening. An actuator is drive-coupled to this control valve to actuate it. At its end oriented away from the at least one injection opening, the nozzle needle has a control piston that is guided in a control chamber so that it is able to execute a stroke motion. On the one hand, this control chamber communicates with the supply line that the control valve is able to control. On the other hand, a suitably throttled outlet line leads away from the control chamber to a leakage chamber and contains a slide valve that is able to control this outlet line. This slide valve is thus a component of the control valve and the actuator consequently actuates it together with the control valve. At its end oriented toward the at least one injection opening, the nozzle needle has a pressure shoulder that acts on the nozzle needle in the opening direction when subjected to pressure.

When the actuator is not being triggered, the control valve closes the supply line and the slide valve opens the outlet line. The nozzle needle is then prestressed into its closed position by means of spring force; the at least one injection opening is thus closed.

With a partial triggering of the actuator, the control valve lifts away from the associated seat, thus opening the supply line and allowing the high fuel pressure to act on the pressure shoulder of the nozzle needle. It is not possible for the high fuel pressure to build up in the control chamber because the outlet line remains open. Correspondingly, the opening forces on the nozzle needle predominate so that the nozzle needle opens and an injection takes place.

With a full triggering of the actuator, the control valve opens further and the slide valve closes the outlet line. It is therefore possible for the high fuel pressure to then also build up in the control chamber so that the closing forces on the nozzle needle now predominate and drive it into the closed position. The cost required for this actuation of the nozzle needle is relatively high.

### ADVANTAGES OF THE INVENTION

The injection nozzle according to the present invention, with the characteristics of the independent claim, has the advantage over the prior art that it is possible to control the nozzle needle directly through the actuation of the control piston. This is possible in that both a compensator surface of the nozzle needle and a control surface of the control piston are subjected to the high fuel pressure; the control surface and the compensator surface are coupled to each other via a corresponding hydraulic path. This means that a change in the pressure acting on the control surface, which is brought about by a triggering of the actuator, i.e. the control piston, also has a direct effect on the compensator surface of the nozzle needle, which directly changes the equilibrium of forces acting on the nozzle needle in order to open or close the nozzle needle. The cost for implementing this kind of direct nozzle needle control is considerably reduced.

In a particularly advantageous embodiment form, the nozzle needle has a pressure shoulder, which, according to the present invention, hydraulically communicates with the supply line on a continuous basis. In this manner, a force component oriented in the opening direction acts on the nozzle needle continuously and is thus directly available to assist the opening motion of the nozzle needle.

According to a preferred embodiment form, in order to open the nozzle needle, it is possible to actuate the control piston so as to produce a decrease in the pressure acting on the first compensator surface associated with the nozzle needle. In this embodiment form, the actuator drives the control piston in the direction in which the first control surface associated with the control piston is already prestressed anyway by the high fuel pressure to which it is subjected. In other words, the actuation of the actuator causes the first control surface to retreat in the direction of the compressive forces being exerted on it. As a result, the actuator does not have to generate any actuating forces, but only has to produce a sufficiently rapid movement of the control piston. This embodiment is advantageous since in modern injection systems, the supply line supplies the fuel to the at least one injection opening at very high pressures, e.g. 800 bar.

A suitable modification is characterized in that the control piston is drive-coupled to the actuator by means of a push rod; the actuator is embodied as a hollow actuator through the center of which the push rod extends. The end of the push rod oriented away from the control piston supports a drive piston that the actuator is able to drive; the actuator is embodied and positioned so that it drives the drive piston in an opening direction of the nozzle needle when triggered. The proposed design makes it possible to drive the control piston in the opening direction of the nozzle needle, which can be advantageous for producing a decrease in the pressure acting on the first control surface.

A particular embodiment form permits the first control surface and the first compensator surface to be situated in a shared conversion chamber; in this instance, the control piston and the compensator piston are guided coaxially one inside the other. In this embodiment form, the first hydraulic path is extremely short since it is more or less contained within the conversion chamber. The nozzle needle is thus actuated in a particularly direct manner.

Other important characteristics and advantages of the injection nozzle according to the present invention ensue from the dependent claims, the drawings, and the accompanying description of the drawings.

### DRAWINGS

Exemplary embodiments of the injection nozzle according to the present invention are shown in the drawings and will be explained in greater detail below; components that are the same or similar or that function in the same manner are labeled with the same reference numerals.

FIGS. 1 through 5 show very simplified schematic longitudinal sections through various embodiment forms of an injection nozzle according to the present invention.

### DESCRIPTION OF THE EXEMPLARY EMBODIMENTS

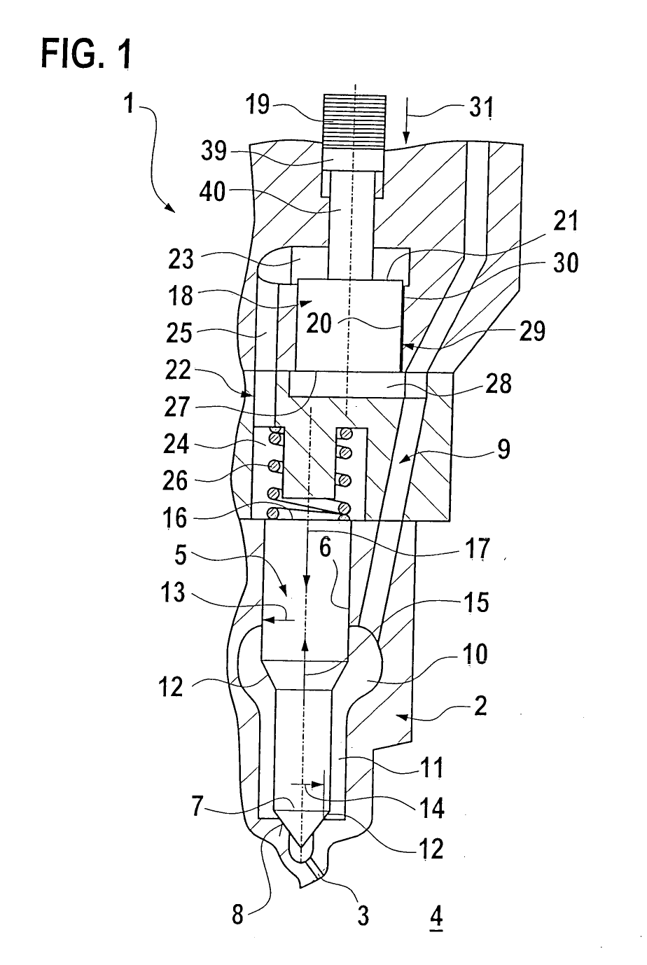

According to FIG. 1, an injection nozzle 1 according to the present invention has a nozzle body 2 that is equipped with at least one injection opening 3. It is clear that the nozzle body 2 usually has more than one injection opening 3. The injection nozzle 1 is able to inject fuel into a combustion chamber or mixture formation chamber 4 via the at least one injection opening 3. In order to control the at least one injection opening 3, the nozzle body 2 has a single nozzle needle 5 that is guided so that it is able to execute a stroke motion in a needle guide 6 inside the nozzle body 2. At its nozzle tip 7 oriented toward the at least one injection opening 3, the nozzle needle 5 cooperates with a sealing seat 8, which is provided in the nozzle body 2 and is usually embodied in an annular form.

The nozzle body 2 contains a supply line 9 that leads in the nozzle body 2 to a nozzle chamber 10 and is supplied with highly pressurized fuel. Usually, the supply line 9 is connected to a high-pressure line that is shared by several injection nozzles 1 in accordance with the so-called “common rail principal”. The common high-pressure line is thus supplied by means of a shared high-pressure pump. It is also possible to supply highly pressurized fuel to the supply line 9 in a different way. For example, the supply line 9 can be directly connected to a high-pressure pump.

It is possible to connect the nozzle chamber 10 to the at least one injection opening 3 via an annular chamber 11, the sealing seat 8 being positioned between the annular chamber 11 and the at least one injection opening 3. Inside the nozzle chamber 10 and the annular chamber 11, the nozzle needle 5 has a pressure shoulder 12 that is oriented toward the at least one injection opening 3. The area of the pressure shoulder 12 is calculated by subtracting a sealing surface 14 in the sealing seat 8 from a guide surface 13 in the cross-section of the needle guide 6. During operation of the injection nozzle 1, the high fuel pressure acts on the pressure shoulder 12 continuously so that the nozzle needle 5 is loaded with an opening force acting in its opening direction 15, which is symbolized by an arrow.

The nozzle needle 5 is associated with a first compensator surface 16 that serves to impart compressive forces to the nozzle needle 5. In the embodiment form depicted in FIG. 1, the first compensator surface 16 is embodied on the nozzle needle 5 itself, at an end oriented away from the at least one injection opening 3. Correspondingly, when subjected to pressure, the first compensator surface 16 acts on the nozzle needle 5 in a closing direction 17, which is symbolized by an arrow. In this instance, the compensator surface 16 is larger than the pressure shoulder 12 so that in order to close the nozzle needle 5 or keep it closed, it is sufficient to subject the first compensator surface 16 to the high fuel pressure.

The injection nozzle 1 is also equipped with a control piston 18 drive-coupled to an actuator 19. The actuator 19 serves to move the control piston 18 and can be embodied, for example, in the form of a piezoelectric actuator. In this connection, the actuator 19 triggers a drive piston 39 attached to a push rod 40, which is in turn attached to the control piston 18. Basically, however, it is also possible to provide other drive couplings between the actuator 19 and the control piston 18.

The control piston 18 is supported in the nozzle body 2 so that it is able to execute a stroke motion in a control piston guide 20 and has a first control surface 21. Inside the nozzle body 2, a first hydraulic path 22 is provided, which hydraulically couples the first control surface 21 to the first compensator surface 16. In this context, a hydraulic coupling is understood to be a pressure transmission path that is able to transmit pressure acting on the first control surface 21 to the first compensator surface 16 and vice versa.

In the embodiment form according to FIG. 1, the first control surface 21 is contained in a first control chamber 23 and can be acted on therein by a pressure. Correspondingly, the first compensator surface 16 is also contained in a first compensator chamber 24 and can be acted on therein by a pressure. The first control chamber 21 communicates with the first compensator chamber 24 via a connecting line 25. In the current instance, the first hydraulic path 22 thus leads through the first control chamber 23, the connecting line 25, and the first compensator chamber 24.

The first compensator chamber 24 also contains a return spring 26, which is supported against the nozzle body 2 at one end and against the first compensator surface 16 at the other, and drives the nozzle needle 5 in its closing direction 17.

The first control surface 21 is situated on an end of the control piston 18 oriented away from the at least one injection opening 3. In the embodiment form shown here, the control piston 18 is also equipped with a second control surface 27, which is situated at the end opposite from the control surface 21 and is thus oriented toward the at least one injection opening 3. The second control surface 27 is contained in a second control chamber 28 and can be acted on therein by a pressure. The second control chamber 28 communicates with the supply line 9 so that the high fuel pressure prevails in the second control chamber 28.

The nozzle body 2 also contains a second hydraulic path 29 that hydraulically couples the first control chamber 23 to the second control chamber 28 and the supply line 9. This means that the high fuel pressure of the supply line 9 and the second control chamber 28 is also present in the first control chamber 23. In the particular embodiment form depicted here, a control piston bypass 30 is embodied radially between the control piston 18 and the control piston guide 20, thus connecting the first control chamber 23 to the second control chamber 28. This control piston bypass 30 can be embodied, for example, by means of an axial groove in the control piston 18 and/or in the control piston guide 20 or by means of a corresponding radial play between the control piston 18 and the control piston guide 20. The control piston bypass 30 produces a throttled connection between the two control chambers 23 and 28. This means that in static states, i.e. when the control piston 18 is stationary or is only moving at a low speed, the control piston bypass 30 permits a pressure compensation between the control chambers 23 and 28. During dynamic events, i.e. during adjusting movements of the control piston 18 occurring at comparatively high adjusting speeds, the throttled control piston bypass 30 is only able to achieve a pressure compensation between the control chambers 23 and 28 after a significant delay.

In the embodiment form depicted in FIG. 1, the injection nozzle 1 of the present invention functions as follows:

In an initial state depicted in FIG. 1, the actuator 19 is not triggered; the control piston 18 is therefore stationary. The supply line 9 is subjected to the high fuel pressure so that this high fuel pressure is also present in the nozzle chamber 10, the annular chamber 11, and the second control chamber 28. In the static state, the second hydraulic path 29 is able to achieve a pressure compensation between the control chambers 23 and 28 so that the high fuel pressure correspondingly is also present in the first control chamber 23. The high fuel pressure consequently is also present in the first compensator chamber 24 via the first hydraulic path 22. On the one hand, the high fuel pressure cooperates with the first compensator surface 16 to act on the nozzle needle 5 in the closing direction 17. On the other hand, the high fuel pressure in the nozzle chamber 10 and in the annular chamber 11 cooperates with the pressure shoulder 12 to act in the opening direction 15. Since the first compensator surface 16 is larger than the pressure shoulder 12, this yields a net resulting force acting on the nozzle needle 5 in the opening direction 17. The return spring 26 also acts on the nozzle needle 5 in the closing direction 17. This correspondingly presses the needle tip 17 of the nozzle needle 15 against the sealing seat 8. The nozzle needle 5 is thus closed and disconnects the at least one injection opening 3 from the annular chamber 11 and from the fuel supply line 9.

In order to trigger a fuel injection through the at least one injection opening 3 into the combustion chamber 4, the actuator 19 is triggered so that it drives the control piston 18 to execute an opening stroke 31, which is symbolized by an arrow. On the one hand, the opening stroke 31, which is executed at a relatively high adjusting speed, reduces the volume of the second control chamber 28. The fuel thus displaced is able to escape into the supply line 9. On the other hand, the opening stroke 31 increases the volume of the first control chamber 23. Since the second hydraulic path 29 is unable to achieve a pressure compensation between the control chambers 23 and 28 during dynamic events, or is only able to do so in a delayed fashion, a pressure decrease therefore occurs in the first control chamber 23. This pressure decrease is transmitted directly into the first compensator chamber 24 via the first hydraulic path 22 so that only a reduced pressure acts on the first compensator surface 16. The opening stroke 31 here is selected so that the decrease in the pressure acting on the first compensator surface 16 changes the balance of forces acting on the nozzle needle 5, yielding a resulting force that then acts in the opening direction 15. This means that the high fuel pressure still acting on the pressure shoulder 12 of the nozzle needle 5 predominates. Correspondingly, the nozzle needle 5 lifts away from the seat 8, i.e. the nozzle needle 5 opens. Consequently, fuel is then able to flow at high pressure to the at least one injection opening 3 and is injected through it into the combustion chamber 4.

In order to terminate the injection process, the actuator 19 is reset. This reduces the volume in the first control chamber 23, as a result of which the pressure in this first control chamber 23 increases. This pressure increase is once again transmitted via the first hydraulic path 22 until it reaches the first compensator surface 16. The resulting pressure can easily exceed the high fuel pressure. Moreover, the return spring 26 also assists the closing motion of the nozzle needle 5. In any case, this yields a net resulting force acting on the nozzle needle 5 in the closing direction 17. It is clear that the opening and closing of the nozzle needle 5 occurs within a very short period of time, i.e. in a highly dynamic fashion, so that although small quantities of fuel can in fact flow from the second control chamber 28 into the first control chamber 23 via the second hydraulic path 29, this fuel flow is certainly insufficient to generate a pressure increase in the first control chamber 23 that would close the nozzle needle 5.

The injection nozzle 1 according to FIG. 1 features a particularly simple design that also permits a direct triggering of the nozzle needle 5 via the control piston 8. It is important here that the high fuel pressure acts on the pressure shoulder 12 even when the nozzle needle 5 is closed. Another advantage to this embodiment form is that when subjected to pressure, the first compensator surface 16 acts in the closing direction 17 so that the only thing required to open the nozzle needle 5 is a decrease in the pressure acting on the first compensator surface 16. The forces required to produce a pressure drop, however, are comparatively low, which permits the achievement of very low net actuating times.

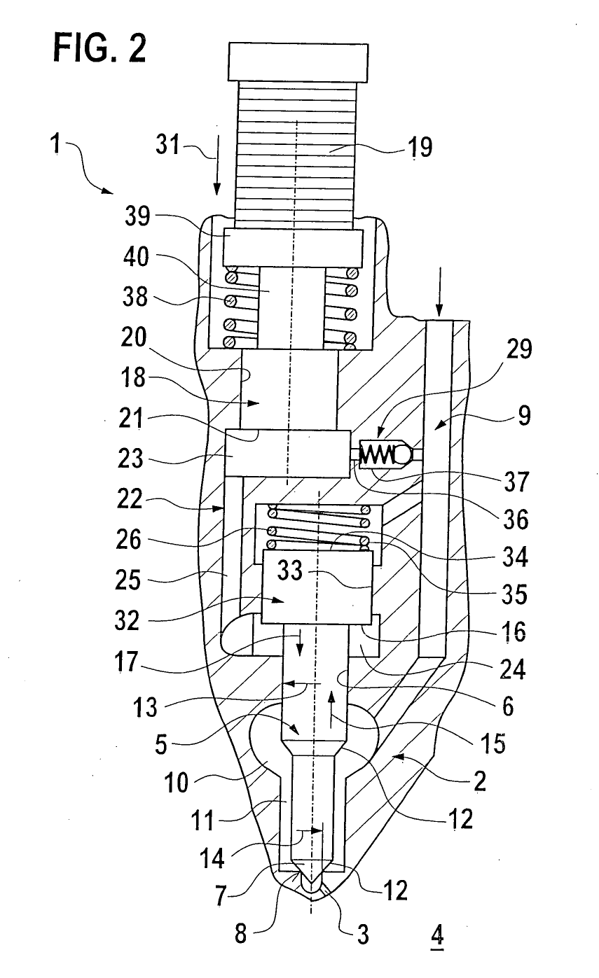

FIG. 2 shows a second exemplary embodiment of an injection nozzle 1 according to the present invention; due to similarities to the first exemplary embodiment according to FIG. 1 with regard to components and functions, reference is hereby made to the relevant statements made in relation to FIG. 1 and the discussion below will essentially concentrate on the differences.

In the embodiment form of the injection nozzle 1 according to FIG. 2, the first compensator surface 16 is embodied on a compensator piston 32, which is guided in the nozzle body 2 so that it is able to execute a stroke in a compensator piston guide 33 and is drive-coupled to the nozzle needle 5. Preferably, the compensator piston 32 is attached to the nozzle needle 5 and in particular, can be integrated into it or of one piece with it. Likewise, is basically also possible for the nozzle needle 5 and compensator piston 32 to be placed against each other end to end, without being attached to each other. It is possible in this case for the prevailing pressure ratios to cause the nozzle needle 5 and compensator piston 32 to move together as a unit, continuously engaged by forces that press the two components together at their ends.

It is also worth noting here that the first compensator surface 16, like the pressure shoulder 12, is oriented toward the at least one injection opening 3 and therefore acts in the opening direction 15 when subjected to pressure. On an end oriented away from the at least one injection opening 3, the compensator piston 32 has a second compensator surface 34 correspondingly oriented away from the first compensator surface 16. The second compensator surface 34 is contained in a second compensator chamber 35 and can be acted on therein by a pressure. The second compensator chamber 35 communicates with the supply line 9 so that the high fuel pressure is continuously exerted on the second compensator chamber 35. The high fuel pressure acting on the second compensator surface 34 generates a force acting in the closing direction 17 on the unit composed of the compensator piston 32 and nozzle needle 5.

Here, too, the first hydraulic path 22 leads from the first compensator surface 16, through the first compensator chamber 24, the connecting line 25, and the first control chamber 23, to the first control surface 21. The second hydraulic path 29 does in fact couple the first control surface 21 to the supply line 9, but in this embodiment form, includes an inlet line 36 that contains an inlet valve 37. The inlet valve 37 here is embodied in the form of a check valve that closes in the direction toward the supply line 9 and opens in the direction toward the first control chamber 23 and is also spring-loaded in its closing direction.

In addition, this embodiment form contains an additional spring 38 that serves to return the control piston 18 and is supported against the nozzle body 2 at one end and against the drive piston 39 at the other.

The embodiment form of the injection nozzle 1 according to the present invention shown in FIG. 2 functions as follows:

In the initial state depicted in FIG. 2, the nozzle needle 5 is closed, i.e. the needle tip 7 rests against the needle seat 8, thus disconnecting the at least one injection opening 3 from the supply line 5. In the initial state, the inlet line 36 permits a pressure compensation between the supply line 9 and the first control chamber 23 so that the high fuel pressure essentially prevails in the first control chamber 23. The first hydraulic path 22 also connects the high fuel pressure to the first compensator surface 16. In addition, the high fuel pressure is continuously present in the second compensator chamber 35 so that it also acts on the second compensator surface 34. The compensator surfaces 16, 34 and the pressure shoulder 12 are matched to one another so that in the initial state, a resulting force acting in the opening direction 17 is exerted on the nozzle needle 5 or on the unit comprised of the compensator piston 32 and nozzle needle 5. This presses the needle tip 7 of the nozzle needle 5 against the sealing seat 8. The return spring 26 also acts in the closing direction and exerts an additional closing force on the nozzle needle 5.

In order to inject fuel into the combustion chamber 4, the actuator 19 is now triggered so that the control piston 18 executes an opening stroke 31, as before. In so doing, the first control surface 21 of the control piston 18 plunges deeper into the first control chamber 23, thus reducing the volume of the first control chamber 23. This produces a pressure increase in the first control chamber 23; on the one hand, this pressure increase closes the inlet valve 37 and prevents fuel from escaping from the first control chamber 23 through the inlet line 36 into the supply line 9. On the other hand, the increasing pressure is transmitted from the first control chamber 23 directly into the first compensator chamber 24. Consequently, the pressure acting on the first compensator surface 16 also increases, thus increasing the forces acting in the opening direction 15 on the unit comprised of the compensator piston 32 and nozzle needle 5. By contrast, the pressure in the second compensator chamber 35 remains constant so that the forces acting on the unit comprised of the compensator piston 32 and nozzle needle 5 in the closing direction remain constant. The pressure increase produced by the opening stroke 31 is of sufficient magnitude to change the balance of forces acting on the unit comprised of the compensator piston 32 and nozzle needle 5, yielding a resulting force that then acts in the opening direction 15. As a result, the nozzle needle 5 lifts away from its sealing seat 8, and the at least one injection opening 3 communicates with the supply line 9. Consequently, fuel is then injected through the at least one injection opening 3 into the combustion chamber 4.

In order to terminate the injection process, the actuator 19 is triggered to reset the control piston 18; the spring 38 assists the resetting movement of the control piston 18. This increases the volume of the first control chamber 23 again so that the pressure in the first control chamber 23 decreases again by a corresponding amount. This pressure decrease is transmitted via the first hydraulic path 22 again until it reaches the first compensator chamber 24. The resulting decrease in the pressure against the first compensator surface 16 once again changes the balance of forces acting on the unit comprised of the compensator piston 32 and nozzle needle 5, yielding a resulting force that once again acts in the closing direction 17. The resulting compressive force, assisted by the return spring 26, consequently drives the unit comprised of the compensator piston 32 and nozzle needle 5 into the closed position of the nozzle needle 5. As soon as the needle tip 7 travels into its sealing seat 8 again, the at least one injection opening 3 is once again disconnected from the supply line 9, thus terminating the injection process.

The embodiment form shown in FIG. 2 also features a particularly simple design and functions with a direct triggering of the nozzle needle 5. By contrast with the embodiment form shown in FIG. 1, in the variant according to FIG. 2, the pressure against the first compensator surface 16 is increased in order to open the nozzle needle 5.

While the control piston 18 is being reset, the pressure in the first control chamber 23 and therefore in the first compensator chamber 24 essentially cannot fall below the high fuel pressure since the inlet line 36 contributes to a corresponding pressure compensation by means of the correspondingly functioning inlet valve 37.

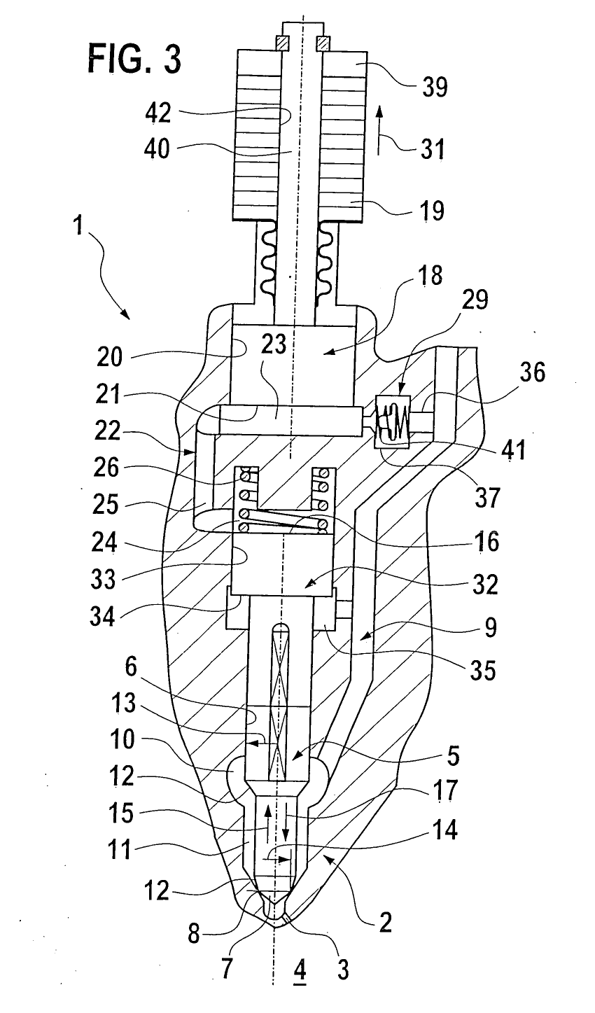

FIG. 3 shows a third exemplary embodiment of an injection nozzle 1 according to the present invention; due to similarities to the preceding exemplary embodiments according to FIGS. 1 and 2 with regard to components and functions, reference is hereby made to the relevant statements made in relation to FIGS. 1 and 2 and the discussion below will essentially concentrate on the differences.

In the embodiment form depicted in FIG. 3, the first compensator surface 16 on the compensator piston 32 is situated at an end oriented away from the at least one injection opening 3 so that it acts in the closing direction 17 when subjected to pressure. Consequently, the second compensator surface 34 at the opposite end acts in the opening direction 15. In this embodiment form, the return spring 26 is correspondingly contained in the first compensator chamber 24 and is supported against the nozzle body 2 and against the first compensator surface 16.

In the embodiment form shown here, the inlet valve 37 is designed so that it closes in the event of a pressure drop in the first control chamber 23, thus preventing fuel from flowing out of the supply line 9 and into the first control chamber 23. A spring mechanism 41 contained in the inlet valve 37 assures that in the event of a less intense pressure drop, the inlet valve 37 will still be able to open to permit a pressure compensation between the first control chamber 23 and the supply line 9. In addition or alternatively to the inlet valve 37, the inlet line 36 could also contain a throttle restriction, which, in a manner similar to the throttled control piston bypass 30 of the variant shown in FIG. 1, essentially shuts off the second hydraulic path 29 during dynamic events and permits a pressure compensation during quasi-static states.

In the embodiment form shown in FIG. 3, the actuator 19 is embodied in the form of a hollow actuator that has a central through opening 42 through which the push rod 40 is guided. The drive piston 39 is then attached to the push rod 40 at an end of the actuator 19 oriented away from the control piston 18. By contrast to the previously described embodiment forms, this design permits the actuator 19 to execute an opening stroke 31 that is oriented away from the at least one injection opening 3. With this design, during its opening stroke 31, the control piston 18 is thus moved in the opening direction 15 of the nozzle needle 5. As a result, no force direction reversal is required in the hydraulic coupling between the control piston 18 and the compensator piston 32.

The third embodiment form of the injection nozzle 1 according to the present invention shown in FIG. 3 functions as follows:

In the initial position shown in FIG. 3, the nozzle needle 5 is closed, i.e. its needle tip 7 closes the at least one injection opening 3. The high fuel pressure acts on the pressure shoulder 12. The high fuel pressure is also present in the second compensator chamber 35. In addition, the second hydraulic path 29 is active in the current static state, so that a pressure compensation between the supply line 9 and the first control chamber 23 can take place. Consequently, the high fuel pressure is also present in the first control chamber 23. The high fuel pressure is also present in the first compensator chamber 24 via the first hydraulic path 22. As a result, the same pressure, namely the high fuel pressure, acts on the first compensator surface 16, the second compensator surface 34, and the pressure shoulder 12. Since the first compensator surface 16 is larger than the sum of the second compensator surface 34 and the pressure shoulder 12, the closing force predominates so that the balance of forces acting on the unit comprised of the compensator piston 32 and nozzle needle 5 yields a resulting force acting in the closing direction 17. The return spring 26 also acts in the closing direction.

If an injection process is to be initiated, then the actuator 19 is triggered so that it drives the control piston 18 to execute the opening stroke 31. The opening stroke 31 acting in the opening direction 15 enlarges the first control chamber 23, which causes the pressure in the first control chamber 23 to drop sharply and quickly. On one hand, this dynamic behavior causes the inlet valve 37 to close, thus preventing fuel from flowing out of the supply line 9 into the first control chamber 23. On the other hand, the pressure drop occurring in the first control chamber 23 is transmitted via the first hydraulic path 22 into the first compensator chamber 24. This reduces the force acting on the first compensator surface 16 in the closing direction 17. By contrast, the high fuel pressure continues to act on the pressure shoulder 12 and on the second compensator surface 34. This changes the balance of forces acting on the unit comprised of the compensator piston 32 and nozzle needle 5, yielding a resulting force acting in the opening direction. As a result, the nozzle needle 5 lifts away from its sealing seat 8 so that the highly pressurized fuel travels unhindered to the at least one injection opening 3 and is injected into the combustion chamber 4 via this at least one injection opening 3.

In order to terminate the injection process, the actuator 19 is now triggered so that it moves the control piston 18 back again. This reduces the volume of the first control chamber 23, causing the pressure therein to increase again. At the same time, the spring mechanism 41 in the inlet valve 37 causes the high fuel pressure to build up again very quickly in the first control chamber 23. The pressure increase in the first control chamber 23 caused by the resetting of the control piston 18 is transmitted via the first hydraulic path 22 directly into the first compensator chamber 24 so that the closing force acting on the first compensator surface 16 essentially climbs back to its initial value. The force of the return spring 26 also plays a part. As a result, the balance of forces acting on the unit comprised of the compensator piston 32 and nozzle needle 5 changes again, yielding a resulting force that acts in the closing direction 17 once again. As a result, the nozzle needle 5 travels back into its sealing seat 8 and disconnects the at least one injection opening 3 from the supply line 9.

This embodiment form also features a comparatively simple design and permits a direct actuation of the nozzle needle 5. Like the variant according to FIG. 1, in this embodiment form, too, a drop in the pressure acting on the first compensator surface 16 is triggered in order to open the nozzle needle 5.

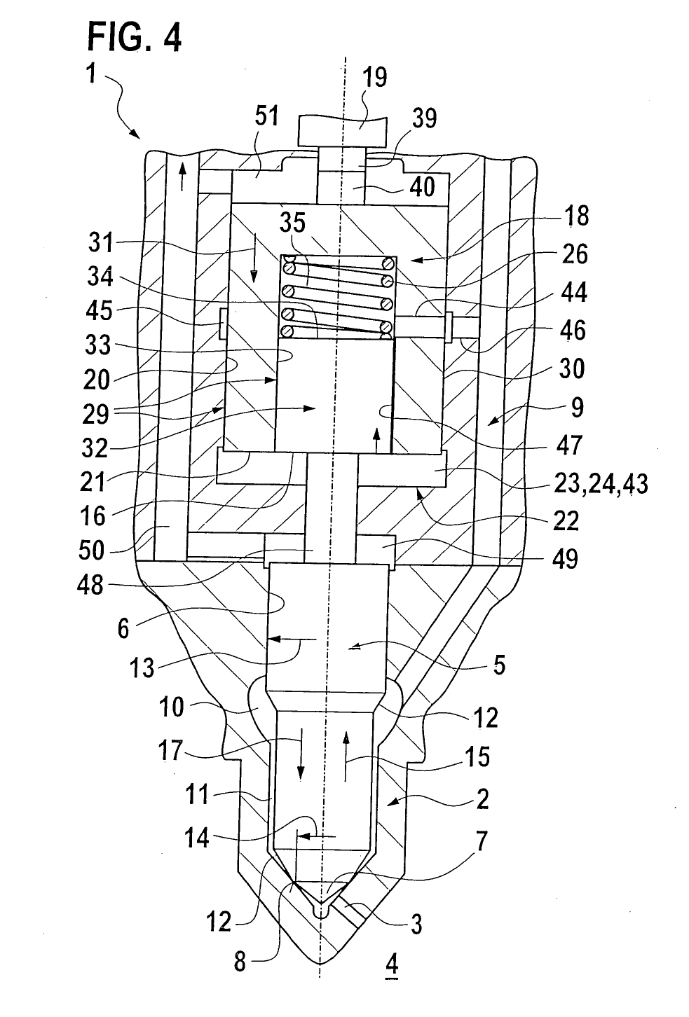

FIG. 4 shows a fourth exemplary embodiment of an injection nozzle 1 according to the present invention; due to similarities to the previously described exemplary embodiments according to FIGS. 1 through 3 with regard to components and functions, reference is hereby made to the relevant statements made in relation to FIGS. 1 through 3 and the discussion below will essentially concentrate on the differences.

According to FIG. 4, in the variant depicted here, the first control surface 21 and the first compensator surface 16 are situated in a shared conversion chamber 43 and can be acted on therein by a pressure. This conversion chamber 43 thus constitutes both the first control chamber 23 and the first compensator chamber 24. In this design, the first hydraulic path 22 is more or less contained inside the conversion chamber 43.

Moreover, the control piston 18 and the compensator piston 32 are guided coaxially one inside the other so that it is possible for the first control surface 21 and the first compensator surface 16 to be situated radially adjacent to each other. In the embodiment form depicted in FIG. 4, this is achieved in that the control piston 18 is embodied in the form of a hollow piston, the inside of which is provided with a compensator piston guide 33 that guides the compensator piston 32 so that it is able to execute a stroke inside the control piston 18.

The inside of the control piston 18 also contains the second compensator chamber 35, which in this case contains the return spring 26 and is delimited by the second compensator surface 34 in the direction toward the at least one injection opening 3. The return spring 26 is supported in the second compensator chamber 35 at one end and against the compensator piston 32 at the other, thus generating a prestressing force that acts on the unit comprised of the compensator piston 32 and nozzle needle 5 in the closing direction 17 and a prestressing force that acts on the control piston 18 in the opening direction 15.

The control piston 18 contains at least one lateral bore 44 that connects the second compensator chamber 35 to an annular groove 45. This annular groove 45 communicates with the supply line 9 via a connecting line 46. As a result the high fuel pressure is continuously present in the second compensator chamber 35.

As in the embodiment form according to FIG. 1, the second hydraulic path 29 can once again be embodied by means of a control piston bypass 30 situated between the control piston 18 and the control piston guide 20 and in this case, connects the annular groove 45 so that it communicates with the conversion chamber 43. In addition or alternatively, it is also possible to provide a compensator piston bypass 47 situated radially between the compensator piston 32 and the compensator piston guide 33, connecting the second compensator chamber 35 so that it communicates with the conversion chamber 43. The control piston bypass 30 and the compensator piston 47 are each embodied as throttled so that only in quasi-static states does a pressure compensation occur between the conversion chamber 43 on one hand and the second compensator chamber 35 and/or the annular groove 45 on the other, whereas in dynamic states, the respective bypass 30, 47 is essentially closed.

In the embodiment form according to FIG. 4, the compensator piston 32 is connected to the nozzle needle 5 by means of a piston rod 48. In the transition region between the piston rod 48 and the nozzle needle 5, a first leakage chamber 49 is provided, which leads via a leakage line 50 to a relatively unpressurized reservoir, in particular the fuel tank. It is therefore possible for leakages that travel along the piston rod 48 from the conversion chamber 43 into the first leakage chamber 49 or along the nozzle needle 5 from the nozzle chamber 10 into the first leakage chamber 49, to be drained off without inducing critical interactions with other components of the injection nozzle 1.

The injection nozzle 1 also has a second leakage chamber 51 that is likewise connected to the leakage line 50 and is situated in the nozzle body 2, at the end of the control piston 18 oriented away from the conversion chamber 43. Leakages the travel along the control piston 18 from the annular groove 45 into the second leakage chamber 51 can thus be drained away without danger to the actuator 19.

The fourth embodiment form of the injection nozzle 1 according to the present invention shown in FIG. 4 functions as follows:

In the initial position depicted in FIG. 4, the nozzle needle 5 is closed, i.e. its needle tip 7 rests against the sealing seat 8, thus disconnecting the at least one injection opening 3 from the supply line 9. In this initial state, the high fuel pressure acts on the pressure shoulder 12. The high fuel pressure is also present in the second compensator chamber 25. The second hydraulic path 29, i.e. the control piston bypass 30 and/or the compensator piston bypass 47 also conveys the high fuel pressure into the conversion chamber 43. In the initial state, the balance of forces acting on the unit comprised of the compensator piston 32, the nozzle needle 5, and the piston rod 48 yields a resulting force acting in the closing direction 17. The nozzle needle 5 is thus pressed into its sealing seat 8 with a corresponding closing force.

In order to execute an injection process, the actuator 19 is triggered so that it drives the control piston 18 to execute the opening stroke 31. The opening stroke 31 in this case is once again oriented toward the at least one injection opening 3, i.e. the first control surface 21 of the control piston 18 pushes into the conversion chamber 43. This generates a pressure increase in the conversion chamber 43, which impinges directly on the first compensator surface 16. Since the opening stroke 31 occurs in a highly dynamic fashion, the increasing pressure in the conversion chamber 43 cannot escape via the throttled bypass paths 30, 47 and thus impinges on the first compensator surface 16 directly. The pressure increase in the conversion chamber 43 thus produces a change in the balance of forces acting on the unit including the nozzle needle 5, yielding a resulting force that now acts in the opening direction 15. As a result, the nozzle needle 5 lifts away from its sealing seat 8. The highly pressurized fuel can then travel to the at least one injection opening 3 and be injected through it into the combustion chamber 4.

In order to terminate the injection process, the actuator 19 is triggered to reset the control piston 18, causing it to pull back out of the conversion chamber 43. As a result, the pressure in the conversion chamber 43 drops rapidly. Here, too, the dynamics of the pressure drop prevent a pressure compensation from occurring via the throttled second hydraulic path 29 so that the pressure drop impinges on the first compensator surface 16 directly. As a result, the balance of forces acting on the unit including the nozzle needle 5 changes again so that the resulting force now acts in the closing direction 17 once more. The nozzle needle 5 then travels back into its sealing seat 8 and closes the at least one injection opening 3. This embodiment form also permits a direct triggering of the nozzle needle 5; the expense required to achieve this is kept relatively low.

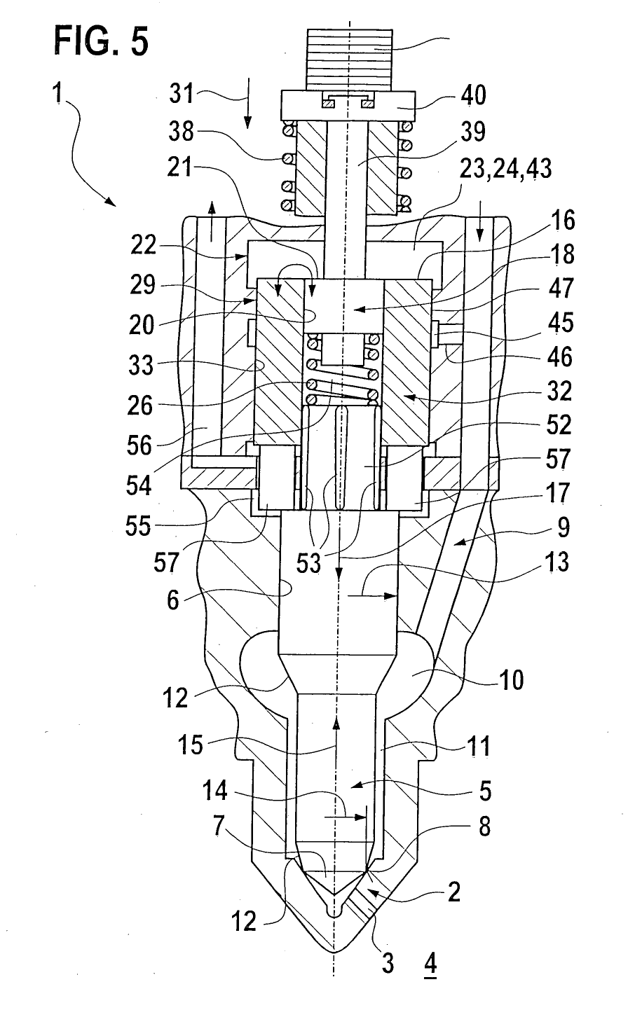

FIG. 5 shows a fifth exemplary embodiment of an injection nozzle 1 according to the present invention; due to similarities to the previously described exemplary embodiments according to FIGS. 1 through 4 with regard to components and functions, reference is hereby made to the relevant statements made in relation to FIGS. 1 through 4 and the discussion below will essentially concentrate on the differences.

In the variant according to FIG. 5, the first control surface 21 and the first compensator surface 16 are once again provided with a shared conversion chamber 43, which simultaneously serves as the first control chamber 23 and first compensator chamber 24 and essentially constitutes the first hydraulic path 22. By contrast with the embodiment form depicted in FIG. 4, in the variant according to FIG. 5, instead of the control piston 18, the compensator piston 32 is embodied in the form of the hollow piston and the control piston 18 is guided so that it is able to execute a stroke motion in the center of the compensator piston 32. The control piston guide 20 is thus embodied on the inside of the compensator piston 32. The inside of the compensator piston 32 is also once again provided with a first leakage chamber 54 in which the return spring 26 is supported against the control piston 18 at one end and against an extension 52 of the nozzle needle 5 at the other. This extension 52 has a number of longitudinal grooves 53 distributed over its circumference, via which the first leakage chamber 54 communicates with a second leakage chamber 55 that is connected to a leakage line 56. The leakage line 56 once again leads to a relatively unpressurized reservoir.

In the region of the second leakage chamber 55, the compensator piston 32 is drive-coupled to the nozzle needle 5 via pins 57. As has already been explained above in connection with the variant according to FIG. 1, it is sufficient if the compensator piston 32 is drive-coupled to the nozzle needle 5 so that only compressive forces can be transmitted. In particular, it is therefore sufficient if the compensator piston 32 rests axially against the pins 57 and they rest axially against the nozzle needle 5. It can also be useful to interconnect the individual components of the unit, which is comprised of the compensator piston 32, the pins 57, and the nozzle needle 5 and is able to execute a stroke motion as a whole.

In the variant according to FIG. 5, the second hydraulic path 29 is routed through the compensator piston bypass 47, which connects the conversion chamber 43 so that it communicates with the annular groove 45; here, too, the hydraulic coupling via the second hydraulic path 29 occurs in a throttled fashion.

The embodiment form of the injection nozzle 1 according to the present invention shown in FIG. 5 functions as follows:

In the initial state depicted in FIG. 5, the nozzle needle 5 closes the at least one injection opening 3 by virtue of the needle tip 7 resting against the sealing seat 8. Since the at least one injection opening 3 is situated downstream of the sealing seat 8, it is thus disconnected from the supply line 9. The pressure shoulder 12 is continuously subjected to the high fuel pressure that is also present in the annular groove 45 via the connecting line 46. Since the initial state is static, the second hydraulic path 29 is active so that a pressure compensation between the annular groove 45 and the conversion chamber 43 takes place by means of the throttled compensator piston bypass 47. Therefore, the high fuel pressure is also present in the conversion chamber 43. This results in a balance of forces acting on the unit including the nozzle needle 5, which yields a resulting force acting in the closing direction 17. The nozzle needle 5 is thus prestressed toward its sealing seat 8.

To initiate an injection process, the actuator 19 is now triggered so that the control piston 18 executes the opening stroke 31. The control piston 18 consequently plunges deeper into the compensator piston 32, causing the first control surface 21 to move in the direction of the opening stroke 31. This causes a pressure drop in the conversion chamber 43. Since the opening stroke 31 is executed in a highly dynamic fashion, a sufficient pressure compensation cannot occur via the compensator piston bypass 47 so that the second hydraulic path 29 is essentially closed. It is therefore possible for the pressure drop occurring in the conversion chamber 43 to be transmitted directly to the first compensator surface 16. This changes the balance of forces acting on the unit, which is able to execute a stroke motion and includes the nozzle needle 5, yielding a resulting force acting in the opening direction 15. As a result, the nozzle needle 5 lifts away from its sealing seat 8. The at least one injection opening 3 is thus connected to the supply line 9 so that the highly pressurized fuel is injected into the combustion chamber 4 by means of the at least one injection opening 3.

To terminate the injection process, the actuator 19 is triggered to reset the control piston 18. This causes a pressure increase in the conversion chamber 43 again, which is transmitted directly to the first compensator surface 16 due to the deactivated second hydraulic path 29. This once again changes the balance of forces acting on the nozzle needle 5, yielding a resulting force acting in the closing direction 17. As a result, the nozzle needle 5 travels back into its sealing seat 8 and once again disconnects the at least one injection opening 3 from the supply line 9.

This embodiment form also permits a direct triggering of the nozzle needle 5 while simultaneously having a relatively simple design.

1-10. (canceled)

11. An injection nozzle for an internal combustion engine for use in a motor vehicle, the injection nozzle comprising
a nozzle body (2) equipped with at least one injection opening (3),
a nozzle needle (5) that is guided in a needle guide (6) of the nozzle body (2) and being able to control the injection of fuel through the at least one injection opening (3),
a control piston (18) drive-coupled to an actuator (19) and having a first control surface (21),
the nozzle needle (5) having a first compensator surface (16) or being drive-coupled to a compensator piston (32) having a first compensator surface (16),
the first compensator surface (16) being hydraulically coupled to the first control surface (21) via a first hydraulic path (22),
a second hydraulic path (29) is able to hydraulically couple the first control surface (21) to a supply line (9) that supplies highly pressurized fuel to the at least one injection opening (3),
the first hydraulic path (22) leading through a first control chamber (23) that contains the first control surface (21), a first compensator chamber (24) that contains the first compensator surface (16), and a connecting line (25) that connects the first control chamber (23) to the first compensator chamber (24), and
the control piston (18) having a second control surface (27) situated in a second control chamber (28) that communicates with the supply line (9).

12. The injection nozzle according to claim 11, wherein the second hydraulic path (29) leads through the first control chamber (23) and a throttled control piston bypass (30), situated between the control piston (18) and a control piston guide (20) and hydraulically connecting the first control chamber (23) to the second control chamber (28).

13. The injection nozzle according to claim 11, wherein in order to open the nozzle needle (5), the control piston (18) is actuated so as to produce a drop in the pressure acting on the first compensator surface (16).

14. The injection nozzle according to claim 12, wherein in order to open the nozzle needle (5), the control piston (18) is actuated so as to produce a drop in the pressure acting on the first compensator surface (16).

15. An injection nozzle for an internal combustion engine for use in a motor vehicle, the injection nozzle comprising
a nozzle body (2) equipped with at least one injection opening (3),
a nozzle needle (5) that is guided in a needle guide (6) of the nozzle body (2) and being able to control the injection of fuel through the at least one injection opening (3),
a control piston (18) drive-coupled to an actuator (19) and having a first control surface (21),
the nozzle needle (5) having a first compensator surface (16) or being drive-coupled to a compensator piston (32) having a first compensator surface (16),
the first compensator surface (16) being hydraulically coupled to the first control surface (21) via a first hydraulic path (22),
a second hydraulic path (29) is able to hydraulically couple the first control surface (21) to a supply line (9) that supplies highly pressurized fuel to the at least one injection opening (3),
the first hydraulic path (22) leading through a first control chamber (23) that contains the first control surface (21), a first compensator chamber (24) that contains the first compensator surface (16), and a connecting line (25) that connects the first control chamber (23) to the first compensator chamber (24),
the compensator piston (32) having a second compensator surface (34) situated in a second compensator chamber (35) that communicates with the supply line (9), and
the two compensator surfaces (16, 34) acting in opposite directions when subjected to pressure.

16. The injection nozzle according to claim 15, wherein the first compensator surface (16) is oriented toward the injection opening (3) and consequently acts in the opening direction (15) and the second hydraulic path (29) has an inlet valve (37) that closes in the direction toward the supply line (9) and opens in the direction toward the first control chamber (23).

17. The injection nozzle according to claim 15, wherein the first compensator surface (16) is oriented away from the injection opening (3) and consequently acts in the closing direction (17) when subjected to pressure, and the second hydraulic path (29) has an inlet valve (37) that prevents fuel from flowing out of the supply line (9) into the first control chamber (23) during an opening stroke (31) off the control piston (18).

18. The injection nozzle according to claim 17, wherein, in order to open the nozzle needle (5), the control piston (18) is actuated so as to produce a drop in the pressure acting on the first compensator surface (16).

19. An injection nozzle for an internal combustion engine for use in a motor vehicle, the injection nozzle comprising
a nozzle body (2) equipped with at least one injection opening (3),
a nozzle needle (5) that is guided in a needle guide (6) of the nozzle body (2) and is able to control the injection of fuel through the at least one injection opening (3),
a control piston (18) drive-coupled to an actuator (19) and having a first control surface (21),
the nozzle needle (5) having a first compensator surface (16) or being drive-coupled to a compensator piston (32) having a first compensator surface (16),
the first compensator surface (16) being hydraulically coupled to the first control surface (21) via a first hydraulic path (22),
a second hydraulic path (29) is able to hydraulically couple the first control surface (21) to a supply line (9) that supplies highly pressurized fuel to the at least one injection opening (3),
the control piston (18) and the compensator piston (32) are guided coaxially one inside the other,
the first control surface (21) and the first compensator surface (16) are situated in a shared conversion chamber (43), and
a second compensator chamber (35) embodied in the control piston (18) and communicating with the supply line (9) through the control piston (18).

20. An injection nozzle for an internal combustion engine for use in a motor vehicle, the injection nozzle comprising,
a nozzle body (2) equipped with at least one injection opening (3),
a nozzle needle (5) that is guided in a needle guide (6) of the nozzle body (2) and being able to control the injection of fuel through the at least one injection opening (3),
a control piston (18) drive-coupled to an actuator (19) and having a first control surface (21),
the nozzle needle (5) having a first compensator surface (16) or being drive-coupled to a compensator piston (32) having a first compensator surface (16),
the first compensator surface (16) being hydraulically coupled to the first control surface (21) via a first hydraulic path (22),
a second hydraulic path (29) is able to hydraulically couple the first control surface (21) to a supply line (9) that supplies highly pressurized fuel to the at least one injection opening (3),
the control piston (18) and the compensator piston (32) being guided coaxially one inside the other,
the first control surface (21) and the first compensator surface (16) being situated in a shared conversion chamber (43), and
the second hydraulic path (29) leading through a compensator piston bypass (47) situated between the compensator piston (32) and a compensator piston guide (33).

21. The injection nozzle according to claim 11, further comprising
a push rod (40) drive-coupled the control piston (18) to the actuator (19),
the actuator (19) being embodied in the form of a hollow actuator through the center of which the push rod (40) is guided,
at an end of the actuator (19) oriented away from the control piston (18), the push rod (40) supporting a drive piston (39) that the actuator (19) is able to drive, and
the actuator (19) being embodied and positioned so that when it is triggered, it drives the drive piston (39) in an opening direction (15) of the nozzle needle (5).

22. The injection nozzle according to claim 12, further comprising
a push rod (40) drive-coupled the control piston (18) to the actuator (19),
the actuator (19) being embodied in the form of a hollow actuator through the center of which the push rod (40) is guided,
at an end of the actuator (19) oriented away from the control piston (18), the push rod (40) supporting a drive piston (39) that the actuator (19) is able to drive, and
the actuator (19) being embodied and positioned so that when it is triggered, it drives the drive piston (39) in an opening direction (I5) of the nozzle needle (5).

23. The injection nozzle according to claim 13, further comprising
a push rod (40) drive-coupled the control piston (18) to the actuator (19),
the actuator (19) being embodied in the form of a hollow actuator through the center of which the push rod (40) is guided,
at an end of the actuator (19) oriented away from the control piston (18), the push rod (40) supporting a drive piston (39) that the actuator (19) is able to drive, and
the actuator (19) being embodied and positioned so that when it is triggered, it drives the drive piston (39) in an opening direction (15) of the nozzle needle (5).

24. The injection nozzle according to claim 14, further comprising
a push rod (40) drive-coupled the control piston (18) to the actuator (19),
the actuator (19) being embodied in the form of a hollow actuator through the center of which the push rod (40) is guided,
at an end of the actuator (19) oriented away from the control piston (18), the push rod (40) supporting a drive piston (39) that the actuator (19) is able to drive, and
the actuator (19) being embodied and positioned so that when it is triggered, it drives the drive piston (39) in an opening direction (15) of the nozzle needle (5).

25. The injection nozzle according to claim 15, further comprising
a push rod (40) drive-coupled the control piston (18) to the actuator (19),
the actuator (19) being embodied in the form of a hollow actuator through the center of which the push rod (40) is guided,
at an end of the actuator (19) oriented away from the control piston (18), the push rod (40) supporting a drive piston (39) that the actuator (19) is able to drive, and
the actuator (19) being embodied and positioned so that when it is triggered, it drives the drive piston (39) in an opening direction (15) of the nozzle needle (5).

26. The injection nozzle according to claim 16, further comprising
a push rod (40) drive-coupled the control piston (18) to the actuator (19),
the actuator (19) being embodied in the form of a hollow actuator through the center of which the push rod (40) is guided,
at an end of the actuator (19) oriented away from the control piston (18), the push rod (40) supporting a drive piston (39) that the actuator (19) is able to drive, and
the actuator (19) being embodied and positioned so that when it is triggered, it drives the drive piston (39) in an opening direction (15) of the nozzle needle (5).

27. The injection nozzle according to claim 17, further comprising
a push rod (40) drive-coupled the control piston (18) to the actuator (19),
the actuator (19) being embodied in the form of a hollow actuator through the center of which the push rod (40) is guided,
at an end of the actuator (19) oriented away from the control piston (18), the push rod (40) supporting a drive piston (39) that the actuator (19) is able to drive, and
the actuator (19) being embodied and positioned so that when it is triggered, it drives the drive piston (39) in an opening direction (15) of the nozzle needle (5).

28. The injection nozzle according to claim 18, further comprising
a push rod (40) drive-coupled the control piston (18) to the actuator (19),
the actuator (19) being embodied in the form of a hollow actuator through the center of which the push rod (40) is guided,
at an end of the actuator (19) oriented away from the control piston (18), the push rod (40) supporting a drive piston (39) that the actuator (19) is able to drive, and
the actuator (19) being embodied and positioned so that when it is triggered, it drives the drive piston (39) in an opening direction (15) of the nozzle needle (5).

29. The injection nozzle according to claim 19, further comprising
a push rod (40) drive-coupled the control piston (18) to the actuator (19),
the actuator (19) being embodied in the form of a hollow actuator through the center of which the push rod (40) is guided,
at an end of the actuator (19) oriented away from the control piston (18), the push rod (40) supporting a drive piston (39) that the actuator (19) is able to drive, and
the actuator (19) being embodied and positioned so that when it is triggered, it drives the drive piston (39) in an opening direction (15) of the nozzle needle (5).
